(19) United States
(12) Patent Application Publication
(10) Pub. No.: US 2012/0077631 A1
(43) Pub. Date: Mar. 29, 2012

(54) V-BELT TRANSMISSION SYSTEM COMBINING FRICTION TRANSMISSION WITH MESH TRANSMISSION

(75) Inventor: Jinfang Wang, Hangzhou (CN)

(73) Assignee: ZHEJIANG KINGLAND TRANSMISSION INDUSTRY CO., LTD., Hangzhou (CN)

(21) Appl. No.: 13/311,160

(22) Filed: Dec. 5, 2011

Related U.S. Application Data
(63) Continuation-in-part of application No. PCT/CN2010/074345, filed on Jun. 23, 2010.

(30) Foreign Application Priority Data
Jun. 23, 2009 (CN) 200910303563.7
Jun. 23, 2009 (CN) 200910303564.1

(51) Int. Cl. F16H 7/02; F16G 1/00

(52) U.S. Cl. 474/149; 474/205

(57) ABSTRACT

A V-shaped belt transmission system includes a small pulley (2) and a large pulley (1). A V-shaped belt (3) winds around the large pulley (1) and the small pulley (2). The V-shaped belt (3) is in friction transmission with the large pulley (1). The transmission between the V-shaped belt (3) and the small pulley (2) is a transmission including the friction transmission with the mesh transmission. The invention provides a V-shaped belt transmission system which can effectively avoid the occurrence of slippage, improve the transmission efficiency, reduce the distortion of the belts, and prolong the service life of the belts, thus addressing the problem of the slippage and idle rotation of the existing belt transmissions.

This application is a continuation-in-part of PCT/CN2010/074345, filed Jun. 23, 2010, which claims priority to Chinese Application No. 200910303564.1, filed Jun. 23, 2009, and Chinese Application No. 200910303563.7, filed Jun. 23, 2009. The PCT/CN2010/074345 application is incorporated herein by reference.

### TECHNICAL FIELD

The invention relates to a transmission system, in particular to a V-shaped belt transmission system for preventing slippage and idle rotation of pulleys in belt transmissions with high power, heavy load and high transmission ratio.

### BACKGROUND

There are a lot of transmission modes in mechanical field, including gear transmission, chain transmission, belt transmission, etc., in which the gear mesh transmission has accurate transmission ratio and can realize high transmission ratio and large loading power, but is only used in the condition that two transmission shafts are positioned in a short distance, when two transmission shafts are set in a long distance, the chain transmission or the belt transmission is usually employed. The chain transmission is mainly realized by engagement between a chain and a sprocket wheel, but its inherent defect of instantaneous impact load causes low driving velocity and is only used for low-speed transmission and in condition without impact load. The engagement or contact between a chain and a sprocket wheel is realized between two rigid members, while the engagement between a belt and a pulley is realized between a rigid member and a flexible (soft) member, and there is an essential difference between the two types of engagements. In the engagement of two rigid members, the meshing characteristics of the two members must be in specific fit, and any slight error will cause clearance meshing and interference meshing. However, when a rigid member is meshed with a flexible member, even interference meshing of the flexible member with the rigid member can satisfy the meshing requirements owing to the flexibility of the flexible member, namely the rigid member can press the flexible member into a desired size to realize engagement. Presently, the belt transmission primarily involves friction transmission (triangle belt or V-shaped belt) and mesh transmission (synchronous belt), wherein the friction transmission is generally suitable for transmissions with large power, heavy load and overload protection requirement and mainly employs members made of rubber or elastic material, and elastic slip and elastic deformation occur inevitably in transmission, thus causing unavoidable slippage and idle rotation in transmission. Synchronous belt transmission designed based on the principle of mesh transmission has accurate transmission ratio and no slippage or idle rotation because of the meshing relationship between a belt and a pulley, but because the synchronous belt is usually thin to keep normal meshing station, it is only suitable for transmission with light load, so that the flexibility of the belt body can be insured, and belt teeth cannot distort. Such structure of the belt body causes it cannot bear a heavy load. If the synchronous belt bears a heavy load, belt teeth will be scraped off by pulley teeth, or the belt body is broken. In the condition of high transmission ratio, the manufacturing difficulty of a large synchronous pulley is very high, and the manufacture process is complex, thereby causing high cost and diseconomy.

The Chinese Patent Publication No. CN1183338 entitled a V-shaped belt System. In the system, the surface of a V-shaped belt is provided with tooth profiles meshed with a synchronous pulley, a large pulley used is a V-shaped grooved pulley, and a small pulley is a synchronous pulley purely driven by mesh transmission. When the system is started, the V-shaped belt slips slightly in the V-shaped grooved pulley to reduce initial starting impact to the system. Therefore, the slippage between the V-shaped belt and the small pulley is overcome because of synchronous engagement. But experiments show that above invention is merely suitable for a belt transmission system with low power and light load. In the conditions of large power and heavy load, tooth gnawing will occur to the transmission belt, namely belt teeth (flexible teeth) are gnawed off by gear teeth (rigid teeth) of the small pulley used for mesh transmission, causing failure of the mesh transmission. Therefore, the system does not solve the problem of slippage and idle rotation in the conditions of large power, heavy load and high transmission ratio and has no practical significance. That is why the above invention cannot be applied as yet. Especially, the patent violates the basic precondition of belt design, that is to say the torsion bearer of a belt should be a core layer or other strong layer of the belt instead of a rubber layer of the belt, thus, the problem of tooth gnawing of the invention cannot be solved resulting from wrong design principle, the situation of tooth gnawing is very serious, and the service life of the belt is too short to work normally.

The Chinese Patent Publication No. CN201187558Y entitled “an oil pumping machine jointed tooth-shaped cog V-shaped belt transmission device”, wherein trapezoidal dummy clubs especially configured on a belt correspond to trapezoidal grooves of a belt pulley to prevent slippage. Without design of eliminating interference, in practical application, the trapezoidal dummy clubs on the belt cannot actually correspond to and be meshed with the trapezoidal grooves of the belt pulley due to elastic slip and elastic deformation of the belt, so interference occurs between the trapezoidal dummy clubs on the belt and the trapezoidal grooves of the belt pulley. The trapezoidal dummy clubs on the flexible (soft) belt is gnawed off by the trapezoidal grooves on the rigid (hard) belt pulley, namely tooth gnawing. Such situation of tooth gnawing will keep going, and the trapezoidal grooves on the rigid (hard) belt pulley keeps gnawing the trapezoidal dummy clubs on the belt until all trapezoidal dummy clubs on the belt are gnawed off. This gnawing has collapse effect, and the belt teeth will be gnawed off within very short time. That all trapezoidal dummy clubs on the belt are gnawed off foreshows the objective of anti-slip by means of the trapezoidal dummy clubs on the belt corresponding to the trapezoidal grooves on the belt pulley cannot be realized.

### SUMMARY

The disclosure relates to a novel V-shaped belt composite transmission system for overcoming defects of various transmission modes in transmission field. The invention provides a V-shaped belt composite transmission system which can effectively prevent slippage, improve the transmission efficiency, reduce the distortion of belts, and prolong the service life of the belts, solving the problems of easy slippage and idle rotation of conventional belts of the prior art.

The V-shaped belt transmission system comprises a small pulley acting as a driving pulley and a large pulley acting as a driven pulley, the small pulley drives the large pulley to rotate through V-shaped belt, and the large pulley is the working pulley. The large pulley is provided with a belt groove fitted with a V-shaped belt, both side surfaces of the belt groove are fitted with both side surfaces of the V-shaped belt to transmit rotational movement by friction between the side surfaces of the belt groove and the V-shaped belt; the small pulley is provided with a belt groove fitted with the V-shaped belt, both side surfaces of the belt groove are fitted with both side surfaces of the V-shaped belt to transmit rotational movement by friction between the side surfaces of the belt groove of the small pulley and the V-shaped belt; the bottom surface of the belt groove of the small pulley is provided with continuously distributed concave-convex teeth; each concave tooth on the bottom surface of the belt groove of the small pulley comprises a meshing section at the bottom, and a belt tooth rolling-in section and a belt tooth rolling-out section symmetrically designed at both sides of the meshing section, and the belt tooth rolling-in section and the belt tooth rolling-out section are connected with convex teeth positioned at both sides of the concave teeth of the small pulley; the internal bottom surface of the V-shaped belt is provided with continuously distributed concave-convex teeth, the convex teeth on the internal bottom surface of the V-shaped belt and the meshing section on the bottom surface of the belt groove of the small pulley are engaged to transmit rotational movement, the concave teeth on the internal bottom surface of the V-shaped belt and the convex teeth on the internal bottom surface of the V-shaped belt have corresponding contours, the convex tooth is designed smaller than the concave tooth of the small pulley so as to remain a clearance with the bottom of the concave tooth of the V-shaped belt, thereby insuring heat dissipation of the belt and the pulley and reducing flex restriction to the belt.

The invention employs a transmission including sliding friction transmission of the large pulley acting as the driven pulley, sliding friction transmission and mesh transmission of the small pulley acting as the driving pulley and rolling friction transmission in overload. In belt transmission, the large pulley and the small pulley have same linear velocity and different angular velocities and contact angles due to different diameters, the contact angle of the large pulley is greater than 180 degrees, and the contact angel of the small pulley is smaller than 180 degrees. As a result of large contact angle and diameter, the length of the V-shaped belt contacting with the large pulley is far longer than the length of the V-shaped belt contacting with the small pulley, the contact area between the V-shaped belt and the large pulley is far larger than the contact area between the V-shaped belt and the small pulley, so slippage concentrates on the small pulley, and idle rotation occurs to the large pulley. The large pulley is the driven pulley, namely working pulley, and thus idle rotation of the large pulley indicates power decrease and work waste. In order to improve the efficiency, the problem of idle rotation must be solved, and accordingly, slippage of the small pulley must be prevented. The meshing section is arranged at the bottom of the belt groove of the small pulley to prevent slippage through mesh transmission between the meshing section and the convex teeth of the V-shaped belt. The V-shaped belt is only in mesh transmission with the small pulley at the meshing section, and among the concave-convex teeth on the small pulley, only the meshing section is designed based on the meshing theory. In the invention, the belt body and the belt teeth of the V-shaped belt are lengthened and enlarged under the action of tension and flex in transmission area except the meshing area of the small pulley, and when entering the meshing area, the enlarged teeth become identical to the gear teeth of the small pulley in shape and size under press of the rigid gear teeth of the small pulley to realize normal engagement. Because only the bottom section of the small pulley is designed based on the meshing theory, and both sides of the meshing section are of the belt tooth rolling-in section and belt tooth rolling-out section, the possibility of the gear teeth of small pulley locking the belt teeth of the V-shaped belt is reduced, thereby preventing the occurrence of tooth gnawing, reducing abrasion of the V-shaped belt and prolonging the service life of the V-shaped belt. The design of tooth shape of the small pulley is totally different from the mesh transmission of a synchronous belt, and because the V-shaped belt composite transmission system of the invention will be applied to equipment with high power, heavy load and high transmission ratio, the meshing principle of the synchronous belt is entirely unsuitable. Meanwhile, the meshing section can be adjusted. The lengthening of the transmission belt caused by elastic deformation of the V-shaped belt can be restored in the meshing section. In normal operation, the convex teeth of the V-shaped belt are in meshing motion with the meshing section of the small pulley, such meshing engagement is not fully engagement between the belt teeth and the gear teeth, the meshing depth is designed smaller than the radius of the belt teeth, and in the condition of shocking load or overload, the belt teeth are permitted to conveniently withdraw from meshing engagement in the belt tooth rolling-in section and the belt tooth rolling-out section of the concave teeth of the small pulley and turn into rolling friction transmission, and such rolling friction transmission is carried out under the restriction of the curve designed between the meshing section of the small pulley and the convex teeth of the V-shaped belt. Therefore, the design insures the accuracy of mesh transmission as well as protects the belt in shocking load or overload. That is the innovation of the invention. In operation of the invention, both side surfaces of the belt and the both side surfaces of the pulleys are in sliding friction transmission, the convex teeth of the V-shaped belt and the meshing section of the pulley are in mesh transmission, the V-shaped belt and the small pulley are in rolling friction transmission when transmission is overloaded or load suddenly changes, and even the belt teeth can upmost climb over the convex teeth of the gear teeth to be in mesh transmission with the meshing section again through the belt tooth rolling-in section. The transmission system combining sliding friction transmission, mesh transmission and rolling friction transmission and skillfully solves the problem of slippage and the problem of overload protection requirement by meshing transmission. Because the belt teeth and the gear teeth are in rolling motion, the conventional sliding friction turns into rolling friction, thereby greatly reducing friction coefficient, significantly prolonging the service life of the belt, and decreasing the friction energy consumption to endow the belt with energy-saving effect. The convex teeth of the pulley are designed to be smaller than the concave teeth on the V-shaped belt such that the convex teeth on the pulley remain a clearance with the bottom of the concave teeth of the V-shaped belt, thereby improving the heat dissipation performance and flex restriction of the belt in operation, and further prolonging the service life of the belt. The convex teeth of the V-shaped belt are designed according to the principle of meshing engagement with the meshing section on the bottom of the belt groove of the pulley, and the concave teeth and the convex teeth of the V-shaped belt having corresponding contours facilitates molding and manufacture.

Preferably, the belt tooth rolling-in section and the belt tooth rolling-out section are in the same shape which is one of circular arc, parabola, involute, elliptical line and cycloid, the curvature radius of the belt tooth rolling-in section and the belt tooth rolling-out section is greater than that of the meshing section, and the curvature radius of the convex teeth of the small pulley is smaller than that of the meshing section. The shape of the belt tooth rolling-in section and the belt tooth rolling-out section insures rolling friction with the V-shaped belt, and the curvature radiuses of the convex teeth, the meshing section, the belt tooth rolling-in section and the belt tooth rolling-out section are sequentially increased. The meshing section is designed based on meshing theory, the curvature radius of the convex teeth of the small pulley is smaller that of the meshing section such that a clearance is remained between the convex teeth of the small pulley and the concave teeth on the V-shaped belt to dissipate heat and reduce the flex restriction of the belt, the belt tooth rolling-in section and the belt tooth rolling-out section have maximum curvature radius and thus can insure that when the small pulley contacts with the V-shaped belt, the convex teeth of the V-shaped belt with elastic deformation can enter the concave teeth of the small pulley to generate mesh transmission without tearing the belt teeth.

Preferably, the belt tooth rolling-in section and the belt tooth rolling-out section are symmetrically distributed at both sides of the meshing section, and the belt tooth rolling-in section and belt tooth rolling-out section are in rolling friction motion with the convex teeth of the V-shaped belt. The belt tooth rolling-in section and the belt tooth rolling-out section are different from the convex teeth of the V-shaped belt in curvature radius so as to insure point contact between them, the belt tooth rolling-in section and the belt tooth rolling-out section and the convex teeth of the V-shaped belt are in rolling friction, and because the rolling friction force is the smallest, so the belt and the small pulley are worn least.

Preferably, the meshing section is in arc transition connection with the belt tooth rolling-in section and the belt tooth rolling-out section, and the belt tooth rolling-in section and the belt tooth rolling-out section are in arc transition connection with the convex teeth of the small pulley. All sections are in arc transition, and thus have good stationarity and improvement of transmission efficiency.

Preferably, the belt groove of the small pulley can be divided into 1 to 100 parallel sub belt grooves in the axial direction of the pulley, the internal bottom surface of the V-shaped belt is axially divided into sub V-shaped belts equal to the sub belt grooves in number, the side surfaces of the sub belt grooves and the side surfaces of the sub V-shaped belts are in sliding friction transmission, and the bottom surfaces of the sub belt grooves and the internal bottom surfaces of the sub V-shaped belts move in transmission combing mesh transmission and rolling friction transmission. Simultaneous transmissions of a plurality of groups improve the transmission efficiency and the transmission torque.

Preferably, the belt structure of the V-shaped belt comprises a cord layer; above the cord layer, a buffer rubber layer, a cord fabric layer, a buffer rubber layer, a wide-angel fabric layer, a buffer layer and a wide-angel fabric layer are sequentially bonded; under the cord layer, a buffer rubber layer, a fiber rubber layer, a buffer rubber layer, a cord fabric layer, a buffer rubber layer, a fiber rubber layer and a buffer rubber layer are sequentially bonded; and the surface of the concave-convex teeth of the V-shaped belt 1 is provided with an elastic fabric layer. The design can increase the rigidity of the transmission belt and prevent break of the transmission belt.

Preferably, a clearance h is remained between the top of the convex teeth of the small pulley and the bottom of the concave teeth of the V-shaped belt, the radius of the convex teeth of the V-shaped belt is expressed as R, 0.2 mm≦h<R, the clearance can be adjusted according to the size of the pulley to insure enough space for dissipating heat to improve the heat dissipation performance.

Preferably, the diameter ratio of the large pulley to the small pulley is 1:1.5 to 1:50, the rotating shaft center distance between the large pulley and the small pulley is larger than the sum of the radiuses of the large pulley and the small pulley, the contact angle of the large pulley is α, the contact angle of the small pulley is β, and α:β=1.1˜3. Synchronous belt transmission cannot be used due to long distance between two pulleys and large torque and load to be transferred.

Therefore, the V-shaped belt transmission system of the invention has the following advantages: because the contact angle of the large pulley is large, and the ratio of the large pulley to the small pulley is large, slippage has little effect on the large pulley, so the large pulley is in sliding friction transmission with the V-shaped belt to increase the pulling force; the contact angle of the small pulley acting as the driving pulley is smaller than 180 degrees, the small pulley is provided with concave-convex teeth, and correspondingly, the V-shaped belt is provided with the same concave-convex teeth, wherein the bottom of each concave-convex tooth of the small pulley is the meshing section, the concave-convex teeth of the V-shaped belt are designed according to the meshing relationship with the meshing section to prevent slippage through mesh transmission, and meanwhile, the belt tooth rolling-in section and the belt tooth rolling-out section are positioned at both sides of the meshing section to prevent tooth gnawing, and the convex teeth of the V-shaped belt can easily roll into the meshing section through rolling friction to realize mesh transmission. The combination of sliding friction transmission between the side surfaces of the V-shaped belt and the small pulley, the rolling friction transmission of the belt tooth rolling-in section and the belt tooth rolling-out section, and the mesh transmission of the meshing section improves the transmission torque and transmission power, prevents the occurrence of tooth gnawing and prolongs the service life of the V-shaped belt.

### BRIEF DESCRIPTION OF THE DRAWINGS

FIG. 1 a perspective view of the V-shaped belt transmission system of the invention at an angle;

FIG. 2 is a perspective view of the V-shaped belt transmission system of the invention at another angle;

FIG. 3 is a front enlargement view of the V-shaped belt winding around the small pulley of the invention;

FIG. 4 is a front enlargement view of D position of FIG. 3;

FIG. 5 is a front enlargement view of D position of the small pulley of FIG. 3;

FIG. 6 is a sectional view of the V-shaped belt of FIG. 1; and

FIG. 7 is a sectional view of the small pulley of FIG. 3.

### DETAILED DESCRIPTION OF THE EMBODIMENTS

The technical scheme of the invention is further described by combining the following embodiments and figures.

### Embodiments

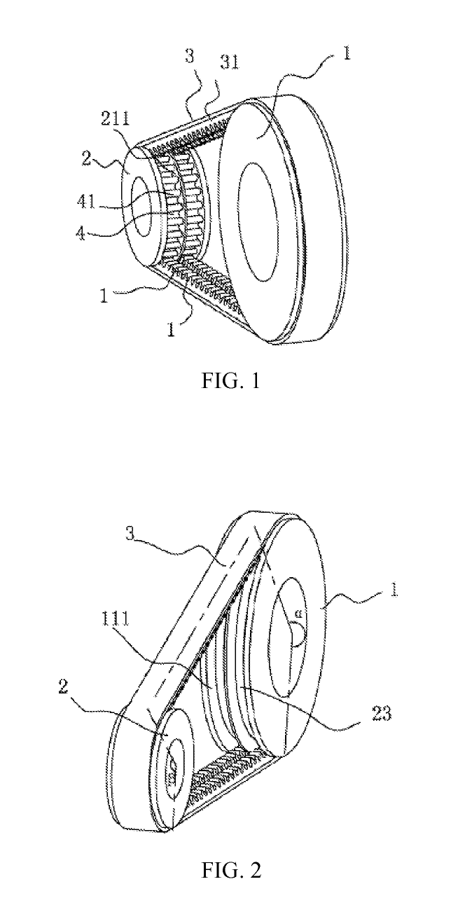

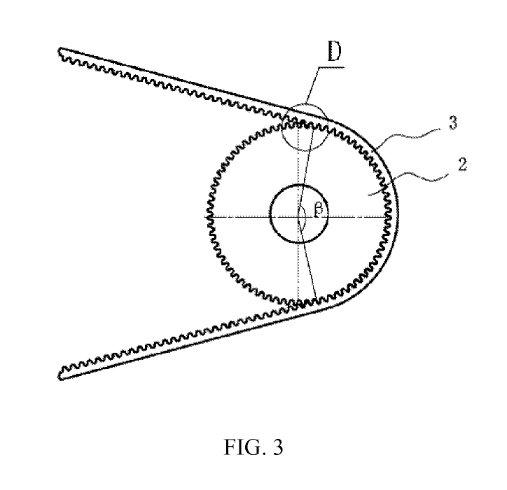

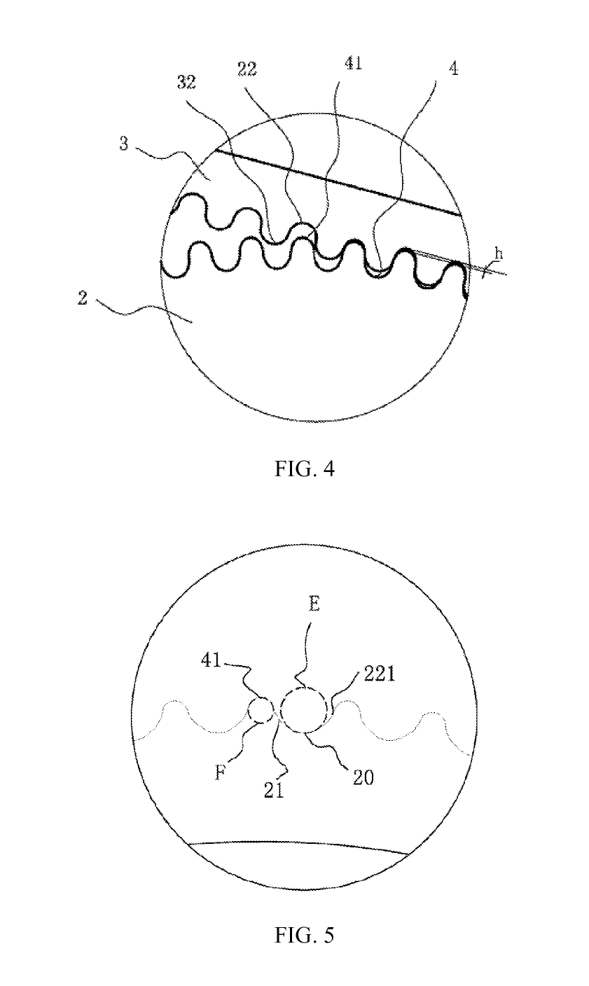

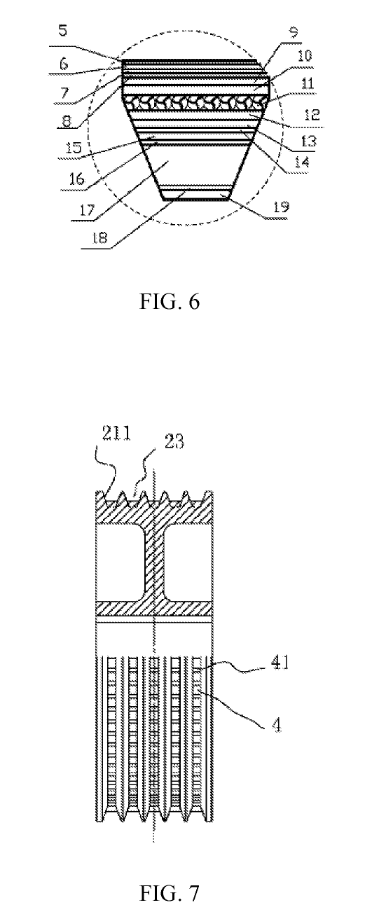

Referring to FIGS. 1, 2 and 3, a V-shaped belt transmission system comprises a large pulley 1 with diameter of 990 mm and a small pulley 2 with diameter of 280 mm, the rotating shaft center distance between the large pulley 1 and the small pulley 2 is 1807.57 mm, the contact angle α of the large pulley 1 is 202.65 degrees, and the contact angle β of the small pulley 2 is 157.35 degrees. The small pulley 2 is the driving pulley, the large pulley 1 is the driven pulley, a V-shaped belt 3 winds around the large pulley 1 and the small pulley 2, and the small pulley 2 drives the large pulley 2 to rotate through the V-shaped belt 3. The large pulley 1 is provided with a belt groove 23, both side surfaces 31 of the V-shaped belt 3 contact with both side surfaces 111 of the belt groove 112 of the large pulley, and the V-shaped belt 3 drives the large pulley 1 to rotate. The outer circumferential surface of the small pulley 2 is provided with a belt groove 23 as well, both side surfaces 211 of the small pulley belt groove 23 contact with and are in friction transmission with both side surfaces 31 of the V-shaped belt 3. In order to prevent slippage, concave-convex teeth are configured on the bottom surface of the belt groove of the small pulley 2 as well as on the internal bottom surface of the V-shaped belt 3. As shown in FIG. 4, a concave tooth 4 of the small pulley comprises a meshing section 20 positioned on the bottom, both sides of the meshing section are connected with a belt tooth rolling-in section 221 and a belt tooth rolling-out section 21 via transition arcs, the belt tooth rolling-in section 221 and the belt tooth rolling-out section 21 have corresponding contours, and the belt tooth rolling-in section 221 and the belt tooth rolling-out section 21 are connected with convex teeth 41 on the bottom surface of the belt groove of the small pulley 2, wherein the height ratio of the meshing section 20 of the small pulley 2 to the belt tooth rolling-in section 221 and the belt tooth rolling-out section 21 is 1:2.5; a convex tooth 32 on the internal bottom surface of the V-shaped belt 3 and the meshing section 20 on the bottom of the concave tooth of the small pulley 2 are in mesh transmission, the concave tooth 22 on the internal bottom surface of the V-shaped belt 3 and the convex tooth 32 on the internal bottom surface of the V-shaped belt 3 are in the same shape, a clearance is remained between the top end of a convex tooth 41 of the small pulley 2 and the bottom of the concave tooth 22 of the V-shaped belt, the distance h of the clearance is 0.72 mm, the height of the meshing section 20 on the small pulley is 1.4 mm, and the radius R of the convex tooth of the V-shaped belt is 2.95 mm. Referring to FIG. 5, a broken circle E in FIG. 5 is an imaginary circle of the meshing section 20, a broken circle F is an imaginary circle on the convex tooth 41 of the small pulley, the belt tooth rolling-in section 221 and the belt tooth rolling-out section 21 are involutes, the belt tooth rolling-in section 21 and the belt tooth rolling-out section 221 are symmetrically arranged at both sides of the meshing section 20, the curvature radius of the convex tooth 41 of the small pulley (which is the radius of circle F) is 1.69 mm, the curvature radius of the meshing section 20 (which is the radius of circle E) of the small pulley is 2.95 mm, the curvature radius of the belt rolling-in section 221 and the belt tooth rolling-out section 21 is greater than that of the meshing section 20, the curvature radius of the convex tooth 41 of the small pulley is smaller than that of the meshing section 20, and because the curvature radius of the belt tooth rolling-in section 221 and the belt tooth rolling out 21 is different from that of the meshing section 21, that is to say, the curvature radius of the belt tooth rolling section 221 and the belt tooth rolling-out section 21 is different from that of the convex tooth 32 of the V-shaped belt 3 as well, rolling friction is generated between the belt tooth rolling-in section 221 and the belt tooth rolling-out section 21 and the convex tooth 32 of the V-shaped belt 3. As shown in FIG. 6, the belt structure of the V-shaped belt 3 comprises a cord layer 11; above the cord layer 11, a buffer rubber layer 10, a cord fabric layer 9, a buffer rubber layer 8, a wide-angel fabric layer 7, a buffer layer 6 and a wide-angel fabric layer 5 are sequentially bonded; under the cord layer 11, a buffer rubber layer 12, a fiber rubber layer 13, a buffer rubber layer 14, a cord fabric layer 15, a buffer rubber layer 16, a fiber rubber layer 17 and a buffer rubber layer 18 are sequentially bonded; and the surfaces of the concave-convex teeth of the transmission belt 1 are provided with elastic fabric layer 19. In order to bear heavier load, a plurality of the large pulleys, the small pulleys and the V-shaped belts can be connected in series in parallel rows. In the invention, the belt groove of either the large pulley or the small pulley is divided into two parallel V-shaped belt grooves 23, and correspondingly, the V-shaped belt is provided with two belt bodies matched with the belt grooves. As shown in FIG. 7, five belt grooves are connected in series to form a joint group, the small pulley is provided with five belt grooves 23, and the side surfaces 31 of the belt grooves 23 and the V-shaped belts are in friction transmission.

When the invention is applied to an oil pumping unit, the torque required by the transmission system is 1200 NM to 2000 NM; because the small pulley 2 is the driving pulley, and the large pulley 1 is the driven pulley, the large pulley 1 rotates merely under the action of sliding friction of the V-shaped belt 3, and the V-shaped belt 3 generating greater friction force can provide a larger traction force, thereby being suitable for situations with heavy load and large torque. Because the contact angle of the small pulley 2 is smaller, the V-shaped belt 3 tends to generate elastic deformation and elastic slide easily in operation, resulting in slippage and thus reducing the service life of the V-shaped belt 3. In order to prevent slippage and reduce the elastic deformation and elastic slide of the V-shaped belt 3, the small pulley 2 as well as the V-shaped belt 3 is provided with a meshing section 20; the belt tooth rolling-in section 221 and the belt tooth rolling-out section 21 are configured at both sides of the meshing section to smooth the entry and the exit of the V-shaped belt through the mesh transmission of the meshing section 20; and the transmission between the small pulley and the V-shaped belt is realized by the cooperation of the friction between the V-shaped belt 3 and the side surfaces 111 of the small pulley, the rolling friction between the belt tooth rolling-in section and the belt tooth rolling-out section 21 and the mesh transmission of the meshing section such that the phenomenon of tooth gnawing cannot occur when insuring large transmission torque, and the service life of the belt is prolonged.

With reference to FIGS. 1-5, the large pulley 1 is provided with a belt groove 23 fitted with a V-shaped belt, both side surfaces 111 of the belt groove 23 are fitted with both side surfaces of the V-shaped belt 3 to transmit rotational movement by friction between the side surfaces 111 of the belt groove 23 and the V-shaped belt 2; the small pulley 2 is provided with a belt groove 23 fitted with the V-shaped belt 3, both side surfaces 211 of the belt groove 23 are fitted with both side surfaces of the V-shaped belt 3 to transmit rotational movement by friction between the side surfaces 211 of the belt groove 23 of the small pulley 2 and the V-shaped belt 3; the bottom surface of the belt groove 23 of the small pulley 2 is provided with continuously distributed concave-convex teeth 41; each concave tooth 41 on the bottom surface of the belt groove 23 of the small pulley 2 comprises a meshing section 20 at the bottom, and a belt tooth rolling-in section 221 and a belt tooth rolling-out section 21 symmetrically designed at both sides of the meshing section, and the belt tooth rolling-in section 221 and the belt tooth rolling-out section 21 are connected with convex teeth positioned at both sides of the concave teeth of the small pulley 2; the internal bottom surface of the V-shaped belt 3 is provided with continuously distributed concave-convex teeth, the convex teeth on the internal bottom surface of the V-shaped belt 3 and the meshing section 20 on the bottom surface of the belt groove 23 of the small pulley 3 are engaged to transmit rotational movement, the concave teeth on the internal bottom surface of the V-shaped belt 3 and the convex teeth on the internal bottom surface of the V-shaped belt 3 have corresponding contours, the convex tooth is designed smaller than the concave tooth of the small pulley 2 so as to remain a clearance with the bottom of the concave tooth of the V-shaped belt 3, thereby insuring heat dissipation of the belt 3 and the pulley 2 and reducing flex restriction to the belt 3.

With reference to FIGS. 1-5, the invention employs a transmission including sliding friction transmission of the large pulley 1 acting as the driven pulley, sliding friction transmission and mesh transmission of the small pulley 2 acting as the driving pulley and rolling friction transmission in overload. Sliding friction transmission utilizes the friction created when two surfaces contact each other. For example, the side surfaces of the V-shaped belt and the side surfaces of the grooves of the large pulley contact each other, and the movement of the V-shaped belt is transmitted to the large pulley by friction created by the contact between the belt and the pulley. The meshing transmission is created between two geared surfaces. The geared surfaces include teeth and grooves. The shape of the teeth is generally complementary to the shape of the grooves. The movement of one geared surface can be transmitted to the movement of the other geared surface when the teeth and grooves of one surface match the complementary grooves and teeth of the other surface. The rolling friction transmission happens when the shape of one surface is not complementary to the shape of the other surface, and therefore the contact between the two surfaces is merely lines or spots. For example, if the teeth and grooves are not complementary to each other in the meshing transmission, the only contacts between the teeth of one surface and the corresponding grooves on the other surface are just the rolling-in and rolling-out sections. Since this is only spot contact, it does not create a meshing transmission, but a rolling friction transmission. In belt transmission, the large pulley 1 and the small pulley 2 have same linear velocity and different angular velocities and contact angles due to different diameters, the contact angle of the large pulley 1 is greater than 180 degrees, and the contact angel of the small pulley 2 is smaller than 180 degrees. As a result of large contact angle and diameter, the length of the V-shaped belt 3 contacting with the large pulley 1 is far longer than the length of the V-shaped belt 3 contacting with the small pulley 2, the contact area between the V-shaped belt 3 and the large pulley 1 is far larger than the contact area between the V-shaped belt 3 and the small pulley 2, so slippage concentrates on the small pulley 2, and idle rotation occurs to the large pulley 1. The large pulley 1 is the driven pulley, namely working pulley, and thus idle rotation of the large pulley 1 indicates power decrease and work waste. In order to improve the efficiency, the problem of idle rotation must be solved, and accordingly, slippage of the small pulley 2 must be prevented. The meshing section 20 is arranged at the bottom of the belt groove 23 of the small pulley 2 to prevent slippage through mesh transmission between the meshing section 20 and the convex teeth of the V-shaped belt 3. The V-shaped belt 3 is only in mesh transmission with the small pulley 2 at the meshing section 20, and among the concave-convex teeth 41 on the small pulley 2, only the meshing section 20 is designed based on the meshing theory. In the invention, the belt body and the belt teeth of the V-shaped belt 3 are lengthened and enlarged under the action of tension and flex in transmission area except the meshing area of the small pulley 2, and when entering the meshing area, the enlarged teeth become identical to the gear teeth of the small pulley 2 in shape and size under press of the rigid gear teeth of the small pulley 2 to realize normal engagement. Because only the bottom section of the small pulley 2 is designed based on the meshing theory, and both sides of the meshing section 20 are of the belt tooth rolling-in section 221 and belt tooth rolling-out section 21, the possibility of the gear teeth 41 of small pulley 2 locking the belt teeth of the V-shaped belt 3 is reduced, thereby preventing the occurrence of tooth gnawing, reducing abrasion of the V-shaped belt and prolonging the service life of the V-shaped belt 3. The design of tooth shape of the small pulley 2 is totally different from the mesh transmission of a synchronous belt, and because the V-shaped belt 3 composite transmission system of the invention will be applied to equipment with high power, heavy load and high transmission ratio, the meshing principle of the synchronous belt is entirely unsuitable. Meanwhile, the meshing section 20 can be adjusted. The lengthening of the transmission belt caused by elastic deformation of the V-shaped belt 3 can be restored in the meshing section 20. In normal operation, the convex teeth of the V-shaped belt 3 are in meshing motion with the meshing section 20 of the small pulley 2, such meshing engagement is not fully engagement between the belt teeth and the gear teeth 41, the meshing depth is designed smaller than the radius of the belt teeth, and in the condition of shocking load or overload, the belt teeth are permitted to conveniently withdraw from meshing engagement in the belt tooth rolling-in section 221 and the belt tooth rolling-out section 21 of the concave teeth of the small pulley 2 and turn into rolling friction transmission, and such rolling friction transmission is carried out under the restriction of the curve designed between the meshing section 20 of the small pulley 2 and the convex teeth of the V-shaped belt 3. Therefore, the design insures the accuracy of mesh transmission as well as protects the belt in shocking load or overload. In operation of the invention, both side surfaces of the belt 3 and the both side surfaces of the pulleys 1, 2 are in sliding friction transmission, the convex teeth of the V-shaped belt 3 and the meshing section 20 of the pulley are in mesh transmission, the V-shaped belt 20 and the small pulley 2 are in rolling friction transmission when transmission is overloaded or load suddenly changes, and even the belt teeth can upmost climb over the convex teeth of the gear teeth 41 to be in mesh transmission with the meshing section 20 again through the belt tooth rolling-in section 221. The transmission system combining sliding friction transmission, mesh transmission and rolling friction transmission and skillfully solves the problem of slippage and the problem of overload protection requirement by meshing transmission. Because the belt teeth and the gear teeth 41 are in rolling motion, the conventional sliding friction turns into rolling friction, thereby greatly reducing friction coefficient, significantly prolonging the service life of the belt, and decreasing the friction energy consumption to endow the belt with energy-saving effect. The convex teeth of the pulley 2 are designed to be smaller than the concave teeth on the V-shaped belt 3 such that the convex teeth on the pulley 2 remain a clearance with the bottom of the concave teeth of the V-shaped belt 3, thereby improving the heat dissipation performance and flex restriction of the belt in operation, and further prolonging the service life of the belt. The convex teeth of the V-shaped belt 3 are designed according to the principle of meshing engagement with the meshing section 20 on the bottom of the belt groove 23 of the pulley 2, and the concave teeth and the convex teeth of the V-shaped belt 3 having corresponding contours facilitates molding and manufacture.

With reference to FIGS. 1-5, the belt tooth rolling-in section 221 and the belt tooth rolling-out section 21 are in the same shape which is one of circular arc, parabola, involute, elliptical line and cycloid, the curvature radius of the belt tooth rolling-in section 221 and the belt tooth rolling-out section 21 is greater than that of the meshing section 20, and the curvature radius of the convex teeth of the small pulley 2 is smaller than that of the meshing section 20. The shape of the belt tooth rolling-in section 221 and the belt tooth rolling-out section 21 insures rolling friction with the V-shaped belt, and the curvature radiuses of the convex teeth, the meshing section 20, the belt tooth rolling-in section 221 and the belt tooth rolling-out section 21 are sequentially increased. The meshing section 20 is designed based on meshing theory, the curvature radius of the convex teeth of the small pulley 2 is smaller that of the meshing section 20 such that a clearance is remained between the convex teeth of the small pulley 2 and the concave teeth on the V-shaped belt 3 to dissipate heat and reduce the flex restriction of the belt, the belt tooth rolling-in section 221 and the belt tooth rolling-out section 21 have maximum curvature radius and thus can insure that when the small pulley 2 contacts with the V-shaped belt 3, the convex teeth of the V-shaped belt 3 with elastic deformation can enter the concave teeth of the small pulley 2 to generate mesh transmission without tearing the belt teeth.

With reference to FIGS. 1-5, the belt tooth rolling-in section 221 and the belt tooth rolling-out section 21 are symmetrically distributed at both sides of the meshing section 20, and the belt tooth rolling-in section 221 and belt tooth rolling-out section 21 are in rolling friction motion with the convex teeth of the V-shaped belt 3. The belt tooth rolling-in section 221 and the belt tooth rolling-out section 21 are different from the convex teeth of the V-shaped belt 3 in curvature radius so as to insure point contact between them, the belt tooth rolling-in section 221 and the belt tooth rolling-out section 21 and the convex teeth of the V-shaped belt 3 are in rolling friction, and because the rolling friction force is the smallest, so the belt and the small pulley are worn least.

With reference to FIGS. 1-5, the meshing section 20 is in arc transition connection with the belt tooth rolling-in section 221 and the belt tooth rolling-out section 21, and the belt tooth rolling-in section 221 and the belt tooth rolling-out section 21 are in arc transition connection with the convex teeth of the small pulley 1. All sections are in arc transition, and thus have good stationarity and improvement of transmission efficiency.

With reference to FIG. 7, the belt groove 23 of the small pulley 2 can be divided into 1 to 100 parallel sub belt grooves 23 in the axial direction of the pulley 2, the internal bottom surface of the V-shaped belt 3 is axially divided into sub V-shaped belts equal to the sub belt grooves in number, the side surfaces of the sub belt grooves and the side surfaces of the sub V-shaped belts are in sliding friction transmission, and the bottom surfaces of the sub belt grooves and the internal bottom surfaces of the sub V-shaped belts move in transmission combing mesh transmission and rolling friction transmission. Simultaneous transmissions of a plurality of groups improve the transmission efficiency and the transmission torque.

With reference to FIG. 6, the surface of the concave-convex teeth of the V-shaped belt 3 is provided with an elastic fabric layer. The design can increase the rigidity of the transmission belt and prevent break of the transmission belt.

With references to FIGS. 1-5, a clearance h is remained between the top of the convex teeth of the small pulley 2 and the bottom of the concave teeth of the V-shaped belt 3, the radius of the convex teeth of the V-shaped belt 3 is expressed as R, 0.2 mm≦h<R, the clearance can be adjusted according to the size of the pulley 2 to insure enough space for dissipating heat to improve the heat dissipation performance.

With reference to FIGS. 1-5, the diameter ratio of the large pulley 1 to the small pulley 2 is 1:1.5 to 1:50, the rotating shaft center distance between the large pulley 1 and the small pulley 2 is larger than the sum of the radiuses of the large pulley 1 and the small pulley 2, the contact angle of the large pulley 1 is α, the contact angle of the small pulley 2 is β, and α:β=1.1˜3. Synchronous belt transmission cannot be used due to long distance between two pulleys and large torque and load to be transferred.

Because the contact angle of the large pulley 1 is large, and the ratio of the large pulley 1 to the small pulley 2 is large, slippage has little effect on the large pulley 1, so the large pulley 1 is in sliding friction transmission with the V-shaped belt 3 to increase the pulling force; the contact angle of the small pulley 2 acting as the driving pulley is smaller than 180 degrees, the small pulley 2 is provided with concave-convex teeth 41, and correspondingly, the V-shaped belt 3 is provided with the same concave-convex teeth, wherein the bottom of each concave-convex tooth of the small pulley 2 is the meshing section 20, the concave-convex teeth of the V-shaped belt 3 are designed according to the meshing relationship with the meshing section 20 to prevent slippage through mesh transmission, and meanwhile, the belt tooth rolling-in section 221 and the belt tooth rolling-out section 21 are positioned at both sides of the meshing section 20 to prevent tooth gnawing, and the convex teeth of the V-shaped belt 3 can easily roll into the meshing section 20 through rolling friction to realize mesh transmission. The combination of sliding friction transmission between the side surfaces of the V-shaped belt and the small pulley, the rolling friction transmission of the belt tooth rolling-in section 221 and the belt tooth rolling-out section 21, and the mesh transmission of the meshing section 20 improves the transmission torque and transmission power, prevents the occurrence of tooth gnawing and prolongs the service life of the V-shaped belt.

The above-mentioned is merely preferred embodiment of the invention and does not limit the invention in any shape or form. The foregoing preferred embodiment is merely illustrative of the invention and is not to be construed in a limiting sense. Various changes and modifications, or equal replacements based on the above-mentioned methods and technical contents will become apparent to those of ordinary skill in the art without departing from the scope of the invention. Therefore, any simple change, equal replacement and modification of the above embodiment based on the technical essence of the invention are seen to fall within the scope of the invention.

1. A belt transmission system comprising:
a driving pulley including a groove that has a bottom surface formed with alternately distributed concave-convex teeth and inner side surfaces, each concave tooth including a meshing section located at a bottom portion of the concave tooth, a belt tooth rolling-in section located along the groove at a side of the meshing section from which a belt tooth rolls in, and a belt tooth rolling-out section located at an opposing side of the belt tooth rolling-in section, wherein the belt tooth rolling-in section and the belt tooth rolling-out section are positioned symmetrically relative to the meshing section;
a driven pulley that has a larger radius than a radius of the driving pulley;
a belt connecting the driving pulley and the driven pulley, the belt being sized to be received in the groove of the driving pulley, the belt including a surface formed with alternately distributed concave-convex teeth and outer side surfaces, each convex tooth of the belt including a meshing section located on a climax portion of the convex tooth, a rolling-in section and a rolling-out section, the meshing section, the rolling-in section and the rolling-out section of the convex tooth are sized to correspond to the meshing section, the belt tooth rolling-in section, the belt tooth rolling-out section of a concave tooth of the driving pulley, the meshing section of the convex tooth of the belt and the meshing section of the concave tooth of the driving pulley engage with each other such that a rotational movement of the driving pulley is conveyed to a linear movement of the belt via a meshing transmission; and
a clearance is present between the meshing section of the convex tooth and the meshing section of the concave tooth when the meshing sections are engaged with each other,
wherein the inner side surfaces of the groove are engagable with respective outer side surfaces of the belt such that the rotational movement of the driving pulley is conveyed to the linear movement of the belt via a sliding friction transmission between the side surfaces of the belt and the groove in combination with the meshing transmission, and rolling friction transmission.

2. The belt transmission system according to claim 1, wherein the belt tooth rolling-in section and the belt tooth rolling-out section have a same shape selected from one of circular arc, parabola, involute, elliptical line and cycloid, a curvature radius of the belt tooth rolling-in section or the belt tooth rolling-out section is greater than a curvature radius of the meshing section, a curvature radius of a meshing section of convex teeth of the driving pulley is smaller than a curvature radius of a meshing section of concave teeth of the driving pulley.

3. The belt transmission system according to claim 1, wherein the belt-tooth rolling in section and the belt tooth rolling-out section are symmetrically distributed at both sides of the meshing section, and the belt tooth rolling-in section and belt tooth rolling-out section are in rolling friction motion with the convex teeth of the belt when the system is overloaded.

4. The belt transmission system according to claim 1, wherein the meshing section is in arc transition connection with the belt tooth rolling-in section and the belt tooth rolling-out section, and the belt tooth rolling-in section and the belt tooth rolling-out section are in arc transition connection with the convex teeth of the driving pulley.

5. The belt transmission system according to claim 1, wherein the belt groove of the driving pulley can be divided into 1 to 100 parallel sub-belt-grooves in in a direction of the rotational axis of the driving pulley, an internal bottom surface of the belt is axially divided into sub-belts corresponding to the sub-belt-grooves, side surfaces of the-sub-belt grooves are engaged with side surfaces of the sub-belts such that the rotational movement of the driving pulley is conveyed to the belt by sliding friction transmission, bottom surfaces of the sub-belt grooves and the respective sub-belts being engaged to transmit movement of the driving pulley to the belt via a combination of mesh transmission, rolling friction transmission.

6. The belt transmission system according to claim 1, wherein the belt comprises a cord layer, a buffer rubber layer, a cord fabric layer, a buffer rubber layer, a wide-angel fabric layer, a buffer layer and a wide-angel fabric layer are sequentially bonded above the cord layer, a buffer rubber layer, a fiber rubber layer, a buffer rubber layer, a cord fabric layer, a buffer rubber layer, a fiber rubber layer and a buffer rubber layer are sequentially bonded under the cord layer; and the surface of the concave-convex teeth of the belt is formed with an elastic fabric layer.

7. The belt transmission system according to claim 1, wherein a clearance is present between a climax portion of each convex tooth of the driving pulley and a bottom portion of a corresponding concave tooth of the belt, the radius of the convex teeth of the belt is expressed as R, 0.2 mm≦h<R.

8. The belt transmission system according to claim 1, wherein a diameter ratio of the driven pulley to the driving pulley is 1:1.5 to 1:50, a rotating shaft center distance between the driven pulley and the driving pulley is larger than a sum of the radiuses of the driven pulley and the driving pulley, a contact angle of the driven pulley is α, a contact angle of the driving pulley is β, and α:β=1.1˜3.

9. A belt for transmitting movements between pulleys, comprising:
a surface formed with alternately distributed concave-convex teeth, each convex tooth including a meshing section located at a bottom portion of the concave tooth, a belt tooth rolling-in section located along a longitudinal direction of the belt relative to the meshing section at a side of the meshing section from which a belt tooth rolls in, and a belt tooth rolling-out section located at an opposing side of the belt tooth rolling-in section,
wherein the belt tooth rolling-in section and the belt tooth rolling-out section are positioned symmetrically relative to the meshing section, and
wherein a curvature radius of a meshing section of each convex tooth of the driving pulley is smaller than a curvature radius of a meshing section of each concave tooth of the driving pulley.

10. A method for conveying a rotational movement of a driving pulley to a belt, comprising:
mounting the belt over the driving pulley,
wherein the driving pulley includes a groove that has a surface formed with alternately distributed concave-convex teeth and inner side surfaces, each concave tooth including a meshing section located at a bottom portion of the concave tooth, a belt tooth rolling-in section located along a longitudinal direction of the groove relative to the meshing section at a side of the meshing section from which a belt tooth rolls in, and a belt tooth rolling-out section located at an opposing side of the belt tooth rolling-in section,
wherein the belt tooth rolling-in section and the belt tooth rolling-out section are positioned symmetrically relative to the meshing section,
wherein a curvature radius of a meshing section of each convex tooth of the driving pulley is smaller than a curvature radius of a meshing section of each concave tooth,
wherein the belt is sized to be received in the groove of the driving pulley, the belt including a surface formed with alternately distributed concave-convex teeth and outer side surfaces, each convex tooth of the belt including a meshing section located on a climax portion of the convex tooth, a rolling-in section and a rolling-out section, the meshing section, the rolling-in section and the rolling-out section of the convex tooth are sized to correspond to the meshing section, the belt tooth rolling-in section, the belt tooth rolling-out section of a concave tooth of the driving pulley, and
wherein a clearance is present between the meshing section of a convex tooth of the belt and the meshing section of the concave tooth on the driving pulley when the meshing sections are engaged with each other,
engaging the meshing section of the belt and the meshing section of the driving pulley to convey the rotational movement of the driving pulley to a linear movement of the belt via meshing transmission; and
engaging the outer side surfaces of the belt with the inner side surfaces of the groove of the driving pulley to convey the rotational movement of the driving pulley to a linear movement of the belt via a combination of meshing transmission and sliding friction transmission.
